(19) United States
(12) Patent Application Publication
(10) Pub. No.: US 2009/0136193 A1
(43) Pub. Date: May 28, 2009

(54) OPTICAL COMPONENT STRUCTURE AND IMAGE SENSOR MODULE USING THE SAME

(75) Inventor: Yasuhiro NAGAO, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto (JP)

(21) Appl. No.: 12/324,270

(22) Filed: Nov. 26, 2008

(30) Foreign Application Priority Data
Nov. 27, 2007 (JP) 2007-305631

(51) Int. Cl. G02B 6/10; G02B 7/02

(52) U.S. Cl. 385/134; 359/811

(57) ABSTRACT

An optical component structure includes an elongate optical component, a support member to which the optical component is fixed, and an adhesive for bonding the optical component to the support member. The optical component is provided with a contacting portion and a bonding portion different in position from the contacting portion. The contacting portion is brought into direct contact with the support member in a direction perpendicular to the longitudinal direction of the optical component. The adhesive is applied to the bonding portion, but not to the contacting portion. Examples of the optical component include a linear light source unit and a lens unit used in an image sensor module.

### BACKGROUND OF THE INVENTION

1. Field of the Invention

The present invention relates to an optical component structure including optical components such as a linear light source unit and a lens unit, for example. The present invention also relates to an image sensor module incorporating such an optical structure.

2. Description of the Related Art

An image sensor module configured to irradiate documents or bills (banknotes) with linear light and then read the reflected light is widely used for a scanner or a bill reader. FIG. 7 shows an example of a conventional image sensor module (see JP-A-2001-197254). The image sensor module X shown in the figure includes a plurality of light emitting elements 92, a lens unit 93, a substrate 94, a plurality of sensor chips 95 and a protective glass 96, which are accommodated in a case 91. The lens unit 93 is bonded to the case 91 with adhesive 97.

The light emitting elements 92 are arranged in the primary scanning direction and emit linear light toward the document Dc. The linear light reflected by the document Dc is converged onto the sensor chips 95 by the lens unit 93. The sensor chips 95 are arranged in the primary scanning direction on the substrate 94. Thus, the content of the document Dc is read as image data.

Generally, the lens unit 93 is thin. For instance, the width of the lens unit 93 is about 1 mm, while the length is about 200 mm. Thus, when the lens unit 93 is bonded to the case 91 with the adhesive 97, the lens unit 93 may warp due to the shrinkage of the adhesive 97. As a result, proper image data cannot be obtained due to the warping of the lens unit 93.

### SUMMARY OF THE INVENTION

The present invention has been proposed under the circumstances described above. It is therefore an object of the present invention to provide an optical component structure whereby the content of an object to be read as image data can be read with little distortion. Another object of the present invention is to provide an image sensor module using such an optical component structure.

According to a first aspect of the present invention, there is provided an optical component structure comprising: an elongate optical component; a support member to which the optical component is fixed; and an adhesive for bonding the optical component to the support member. The optical component includes a contacting portion and a bonding portion different in position from the contacting portion. The contacting portion is brought into direct contact with the support member in a direction perpendicular to the longitudinal direction of the optical component. The adhesive is applied only to the bonding portion.

With the above arrangement, the optical component is properly positioned relative to the support member by the bonding at the contacting portion. Thus, even when the adhesive at the bonding portion shrinks, the optical component does not deviate from the original location relative to the support member.

Preferably, the adhesive may be applied to the optical component at two positions spaced from each other in the longitudinal direction of the optical component so that two lumps of adhesive flank the contacting portion.

Preferably, the adhesive may be applied to the optical component at two positions spaced from each other in a direction perpendicular to the longitudinal direction of the optical component so that the two lumps adhesive flank the optical component.

Preferably, the optical component may comprise a linear light source unit including an elongated light guiding member or may comprise a lens unit including a plurality of columnar lenses for converging reflected light from an object to be read.

According to a second aspect of the present invention, there is provided an image sensor module incorporating an optical component structure mentioned above, where the optical component may include a linear light source unit or a linear lens unit. The image sensor module may further comprise a plurality of light receiving elements arranged in a row for receiving reflected light from an object to be read. The light source unit, the lens unit and the light receiving elements may be accommodated in the support member which is typically a housing case.

Other features and advantages of the present invention will become more apparent from detailed description given below with reference to the accompanying drawings.

### BRIEF DESCRIPTION OF THE DRAWINGS

FIG. 1 is a plan view showing a principal portion of an image sensor module according to a first embodiment of the present invention;

FIG. 2 is a sectional view taken along lines II-II in FIG. 1;

FIG. 3 is a sectional view taken along lines III-III in FIG. 1;

FIG. 4 is a plan view showing a principal portion of an image sensor module according to a second embodiment of the present invention;

FIG. 5 is a sectional view taken along lines V-V in FIG. 4;

FIG. 6 a sectional view taken along lines VI-VI in FIG. 4; and

FIG. 7 is a sectional view showing an example of conventional image sensor module.

### DETAILED DESCRIPTION OF THE PREFERRED EMBODIMENTS

Preferred embodiments of the present invention will be described below with reference to the accompanying drawings.

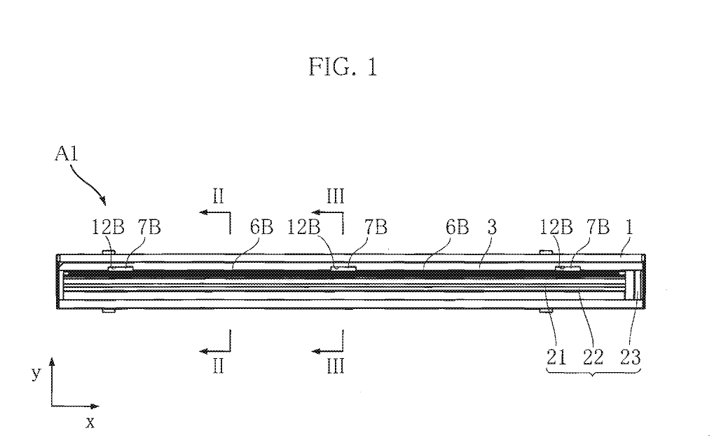

FIGS. 1-3 show an image sensor module according to a first embodiment of the present invention. The image sensor module A1 of this embodiment includes a case (support member) 1, a linear light source unit 2, a lens unit 3, a substrate 4, a plurality of sensor chips 5 and a protective glass 8. The image sensor module A1 has a reading width of about e.g. 200 mm and is designed to be used for a scanner. For easier understanding, the illustration of the protective glass 8 is omitted in FIG. 1.

The case 1 accommodates the linear light source unit 2, the lens unit 3, the substrate 4, the sensor chips 5 and the protective glass 8 and is in the form of a generally rectangular parallelepiped elongated in the primary scanning direction x. The case 1 is made of e.g. black resin and formed with a plurality of recesses 12A and 12B. The recesses 12A are spaced from each other in the primary scanning direction x, so are the recesses 12B.

The linear light source unit 2 is an optical component for emitting linear light extending in the primary scanning direction x toward the document Dc. The linear light source unit 2 includes a light guiding member 21, a reflector 22 and a light source substrate 23. The light guiding member 21 is made of a transparent resin such as methyl methacrylate (PMMA) and in the form of a bar elongated in the primary scanning direction x. The light source substrate 23 is arranged to face an end surface of the light guiding member 21. For instance, a plurality of LED chips (not shown) for emitting red light, green light and blue light are mounted on the light source substrate 23. The light guiding member 21 includes a reflective surface 21a and a light emitting surface 21b which extend in the primary scanning direction x. The light emitted from the LED chips and entering the light guiding member 21 through the above-described end surface is reflected by the reflective surface 21a in a direction perpendicular to the primary scanning direction x. The reflective surface 21a may be formed with a plurality of grooves spaced from each other in the primary scanning direction x. The light traveling from the reflective surface 21a is emitted from the light emitting surface 21b as linear light. The reflector 22 is made of e.g. white resin and covers the light guiding member 21.

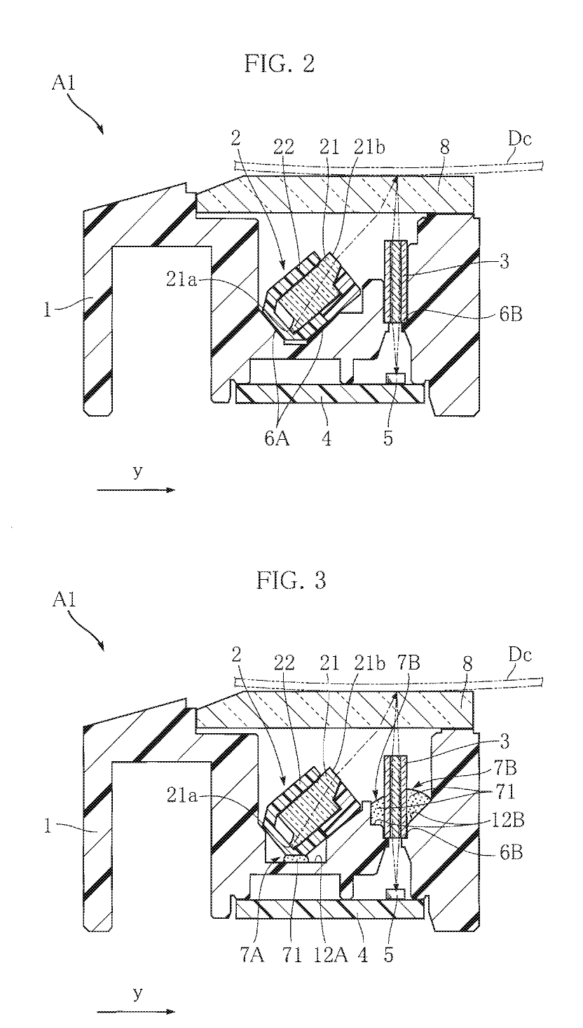

As shown in FIG. 2, the linear light source unit 2 is held in direct contact with the case 1 in a direction perpendicular to the primary scanning direction x at a plurality of locations. These portions constitute contacting portions 6A. As shown in FIG. 3, adhesive 71 is applied between a lower bonding portion of the light source unit 2 and an inner bonding portion of the case 1 at each of the recesses 12A of the case 1. In this manner, the linear light source unit 2 is fixed to the case 1 at the recesses 12A. The applied adhesive 71 constitutes bonding bridges 7A between the unit 2 and the case 1.

The lens unit 3 is an optical component for converging the light reflected by the document Dc onto the sensor chips 5. For instance, the lens unit 3 includes a plurality of columnar lenses arranged in the primary scanning direction x and held by a housing made of resin. As shown in FIG. 2, the lens unit 3 is held in contact with the case 1 in a direction perpendicular to the primary scanning direction x at a plurality of locations. These portions constitute contacting portions 6B. As shown in FIG. 3, adhesive 71 is applied to each of the recesses 12B of the case 1. The lens unit 3 is arranged adjacent to the center of each recess 12B in the secondary scanning direction y. The two side surfaces of the lens unit 3 are bonded to the recess 12B via the adhesive 71. Thus, as shown in FIG. 3, two bonding lumps 7B are formed to sandwich or flank the lens unit 3 in the secondary scanning direction y. In this embodiment, as shown in FIG. 1, the structure shown in FIG. 3 is provided at three locations spaced from each other in the primary scanning direction x.

The substrate 4 is made of e.g. a ceramic material or a glass-fiber-reinforced epoxy resin. The sensor chips 5 are mounted on the substrate 4. The substrate 4 is fitted to a lower portion of the case 1.

The sensor chips 5 are arranged in a row extending in the primary scanning direction x. The sensor chips 5 generate electromotive force corresponding to the received amount of light and output a brightness signal for each pixel from the electromotive force. By receiving the light reflected by the document Dc by the sensor chips 5, the content of the document Dc is read as image data.

The advantages of the image sensor module A1 will be described below.

According to this embodiment, the position of the linear light source unit 2 and the lens unit 3 relative to the case 1 in the direction perpendicular to the primary scanning direction x is determined by the contacting portions 6A and 6B to which no adhesive is applied. Thus, even when the adhesive 71 shrinks at the bonding bridges 7A and bonding lumps 7B, the linear light source unit 2 and the lens unit 3 do not deviate from their original positions.

The bonding bridges and lumps 7A, 7B do not adversely affect the positioning of the linear light source unit 2 and the lens unit 3 relative to the case 1. Thus, the recesses 12A and 12B can be made relatively deep to increase the thickness of the adhesive 71, so that the bonding strength increases. Due to the difference in coefficient of linear expansion, the linear light source unit 2 or the lens unit 3 may expand or contract relative to the case 1. Even in such a situation, the adhesive 71 can accommodate the deviation of the linear light source unit 2 or the lens unit 3 with respect to the case 1. This prevents the linear light source unit 2 or the lens unit 3 from warping and prevents the adhesive 71 from peeling off due to the deviation.

As noted above, the bonding lumps 7B flank the lens unit 3. With this arrangement, the bending forces applied by the respective bonding lumps 7B on the lens unit 3 cancel each other out. Thus, no warping occurs in the lens unit 3.

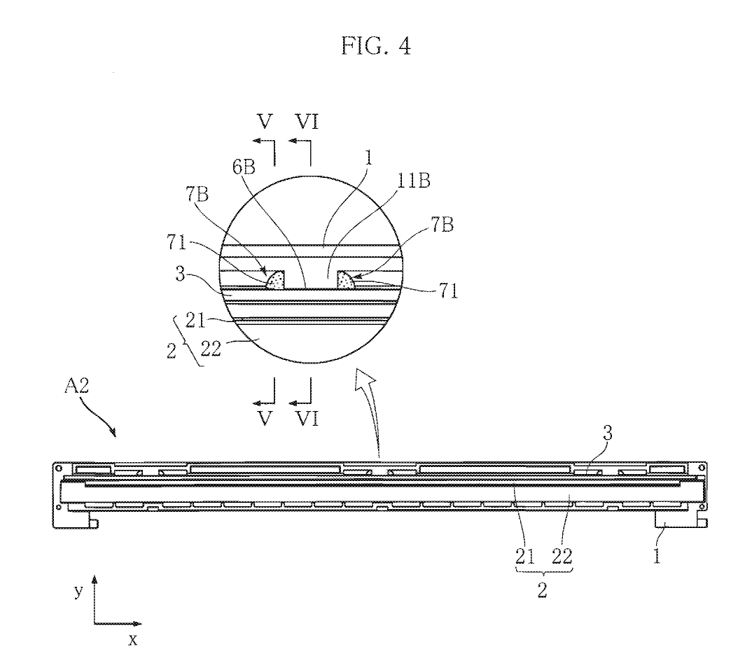

FIGS. 4-6 show an image sensor module according to a second embodiment of the present invention. In these figures, the elements which are identical or similar to those of the foregoing embodiment are designated by the same reference signs as those used for the foregoing embodiment.

The image sensor module A2 of this embodiment differs from that of the foregoing embodiment in structure of the contacting portion 6B and the bonding lump 7B. Specifically, as shown in FIG. 4, two bonding lumps 7B are formed to flank the contacting portion 6B in the primary scanning direction x.

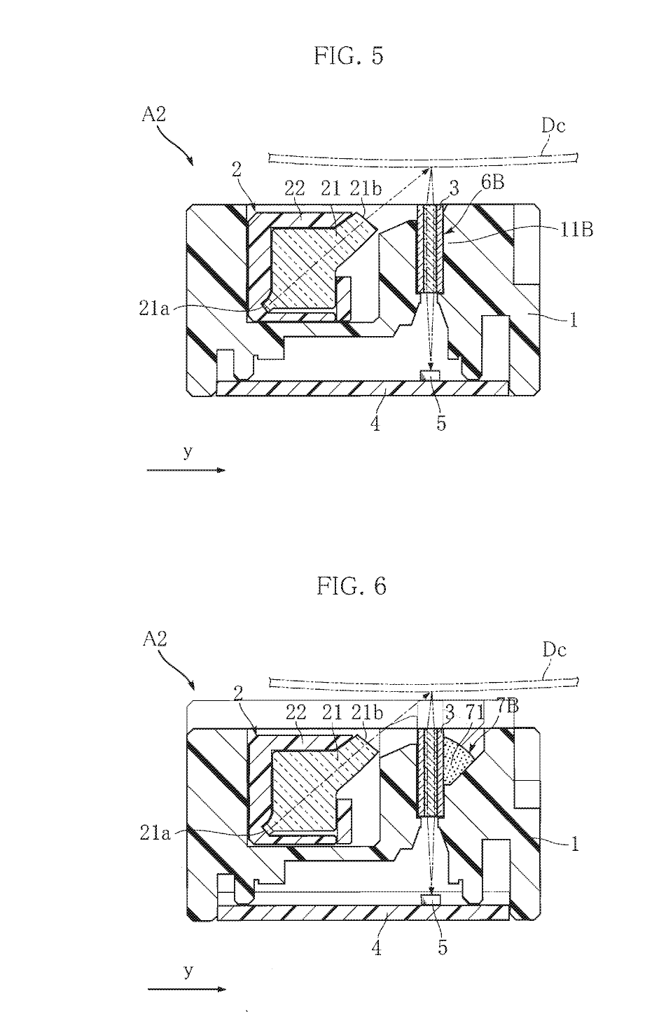

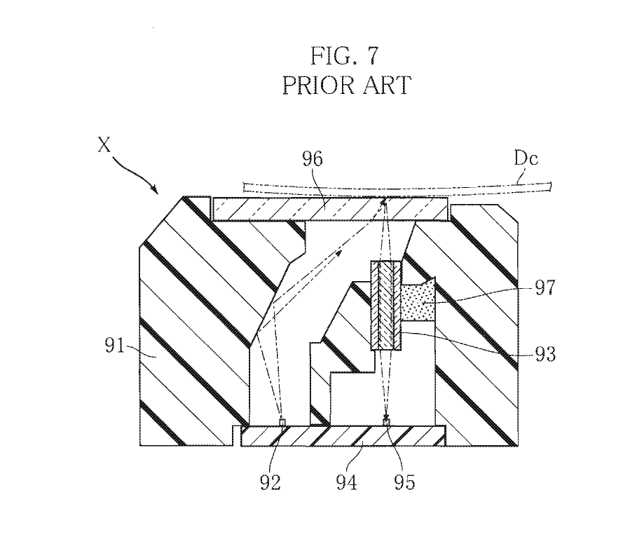

As shown in FIGS. 4 and 5, the case 1 is formed with a plurality of projections 11B arranged in the primary scanning direction x. The projections 11B are held in contact with a side surface of the lens unit 3 in the secondary scanning direction y. These portions constitute contacting portions 6B. As shown in FIG. 6, at portions where the projections 11B are not provided, adhesive 71 is applied between the lens unit 3 and the case 1 to constitute bonding lumps 7B. As shown in FIG. 4, each contacting portion 6B is flanked by two bonding lumps 7B. The bonding lumps 7B are formed on one side of the lens unit 3.

The contacting portions 6A and the bonding bridges 7A of the foregoing embodiment may additionally be provided in the embodiment of FIGS. 4-6, so that the linear light source unit 2 can be more firmly attached to the case 1.

According to this embodiment, the forces applied by the respective bonding lumps 7B due to the shrinkage of the adhesive 71 cancel each other out on the two sides of the contacting portion 6B. This prevents the lens unit 3 from unduly warping.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. An optical component structure comprising:
an elongate optical component;
a support member to which the optical component is fixed; and
an adhesive for bonding the optical component to the support member;
wherein the optical component includes a contacting portion and a bonding portion different in position from the contacting portion, the contacting portion coming into direct contact with the support member in a direction perpendicular to a longitudinal direction of the optical component, the adhesive being applied to the bonding portion.

2. The optical component structure according to claim 1, wherein the adhesive is applied to the optical component at two positions spaced from each other in the longitudinal direction of the optical component and flanking the contacting portion.

3. The optical component structure according to claim 1, wherein the adhesive is applied to the optical component at two positions spaced from each other in a direction perpendicular to the longitudinal direction of the optical component, the two positions flanking the optical component.

4. The optical component structure according to claim 1, wherein the optical component comprises a linear light source unit including an elongated light guiding member.

5. The optical component structure according to claim 1, wherein the optical component comprises a lens unit including a plurality of columnar lenses for converging reflected light from an object to be read.

6. An image sensor module comprising:
an optical component structure in accordance with claim 4;
a lens unit for converging reflected light from an object to be read; and
a plurality of light receiving elements arranged in a row for receiving the light converged by the lens unit;
wherein the lens unit and the plurality of light receiving elements together with the light source unit are accommodated in the support member.

7. An image sensor module comprising:
an optical component structure in accordance with claim 5;
a linear light source unit including an elongated light guiding member; and
a plurality of light receiving elements arranged in a row for receiving the light converged by the lens unit;
wherein the light source unit and the the plurality of light receiving elements together with the lens unit are accommodated in the support member.
